(19) United States
(12) Patent Application Publication
(10) Pub. No.: US 2010/0054842 A1
(43) Pub. Date: Mar. 4, 2010

(54) Slide Up Lipstick Dispenser

(76) Inventors: Ralph DeVito, Oxford, CT (US); Denise D. Soracco, Seymour, CT (US)

Correspondence Address: ST. ONGE STEWARD JOHNSTON & REENS, LLC, 986 BEDFORD STREET, STAMFORD, CT, 06905-5619, US

(21) Appl. No.: 12/202,905

(22) Filed: Sep. 2, 2008

(51) Int. Cl. A45D 40/10; B43K 5/16

(52) U.S. Cl. 401/81; 401/109

(57) ABSTRACT

The invention relates to a cosmetic dispenser for dispensing a cosmetic having an outer shell; a sleeve placed within the outer shell and slidable relative to the outer shell; a cup placed within the sleeve and slidable relative to the sleeve; the sleeve having an orifice; a button located on a side of the outer shell opposite to the sleeve; a bar placed between and attached to the cup and the button; a flexible tab extending downwards from the bar and inwards toward the sleeve, the flexible tab having an endpoint located at a downward and inward location of the flexible tab; and wherein the endpoint is engageable with and disengageable from the orifice for sliding the cup, the sleeve, and the outer shell relative to one another.

### FIELD OF THE INVENTION

The invention relates to a cosmetic dispenser that is typically operable with one hand.

### BACKGROUND OF THE INVENTION

Lipstick is often packaged in two-piece tubes including a base portion for mounting, extending, and retracting the lipstick, together with a separate closure cap which is removed and replaced with each application of the lipstick. For applying lipstick, the cap is normally removed from the tube, the base portion twisted or turned to project a tip of the lipstick from the tube for application, after which the lipstick is retracted with a turn of the base, and the closure cap is replaced. In ordinary use, two hands are normally required to manipulate the tube and apply the lipstick.

In some embodiments, one or more lugs on a lipstick container typically follow a slot formed in an inner body and extending longitudinally in an axial direction along the inner body length. This slot maintains constant angular orientation between the hollow inner body and the lipstick container. A cylindrical internally threaded base is mounted on the radially outward side of the inner body, such that the inner body, the lipstick container, and the threaded base all share a common axis. The lug on the lipstick container extends to the inner body slot to be engaged by the threads, such that when the base is rotated about the common axis relative to the inner body, the lug is urged either upward or downward along said chamber by the action of said threads, depending upon the direction of relative rotation, to thereby either extend or retract said lipstick. Such embodiments are normally associated with a two-handed operation

Over the years, some inventions attempted to develop improved lipstick tubes with particular emphasis on the idea of combining the functions of opening and closing the tube and of extending and retracting the lipstick in the tube. One objective is to achieve one-hand operation of a lipstick tube for freeing the other hand to hold a mirror as the lipstick is applied. However, typical one-handed operating lipstick tubes generally suffer from poor operation, wherein the cosmetic may not smoothly dispense and retract and/or the cosmetic may be damaged by coming in contact with parts of the tubes.

What is desired, therefore, is a cosmetic dispenser that reliably opens and closes and where the lipstick is inhibited from coming in contact with the cover. Another desire is a cosmetic dispenser that is easily operated with one hand in an efficient, ergonomic manner. A further desire is cosmetic dispenser that dispenses the cosmetic after the cover is verified in an open position and closes the cover after the cosmetic is verified to be in a retracted position.

### SUMMARY OF THE INVENTION

It is therefore an object of the invention to provide a cosmetic dispenser that is geared for one-handed operation.

Another desire is a cosmetic dispenser that is assured to open and close without touching the cosmetic.

These and other objects of the invention are achieved by a cosmetic dispenser for dispensing a cosmetic having an outer shell; a sleeve placed within the outer shell and slidable relative to the outer shell; a cup placed within the sleeve and slidable relative to the sleeve; the sleeve having an orifice; a button located on a side of the outer shell opposite to the sleeve; a bar placed between and attached to the cup and the button; a flexible tab extending downwards from the bar and inwards toward the sleeve, the flexible tab having an endpoint located at a downward and inward location of the flexible tab; and wherein the endpoint is engageable with and disengageable from the orifice for sliding the cup, the sleeve, and the outer shell relative to one another.

In some embodiments, the outer shell of the cosmetic dispenser has a slot extending in a longitudinal direction and the cup being fixed to the button by the bar extending through the slot in the outer shell.

In other embodiments, the sleeve of the cosmetic dispenser has a slot extending in a longitudinal direction above the orifice and the cup being fixed to the button by the bar extending through the slot in the sleeve.

In further embodiments, the outer shell includes an opening for permitting the cosmetic to protrude and a door attached to the opening and a spring connected to the door for biasing the door to a closed position.

In another embodiment, the endpoint of the cosmetic dispenser engages with the orifice when the sleeve and the cup slide together; and the endpoint disengages from the orifice when the cup slides relative to the sleeve.

In one embodiment, the flexible tab is a leaf spring or is accurate in shape as it extends downward from the bar and inward toward the sleeve. In a further embodiment, the sleeve has a detent for inhibiting the sleeve from moving through the opening.

In another aspect of the invention, a method for providing the cosmetic dispenser includes the steps of: providing an outer shell; placing a sleeve within the outer shell that is slidable relative to the outer shell; placing a cup within the sleeve that is slidable relative to the sleeve; placing an orifice in the sleeve; placing a button on a side of the outer shell opposite to the sleeve; attaching a bar between the cup and the button to connect the button and cup together; extending a flexible tab downwardly from the bar and inwardly toward the sleeve; placing an endpoint of the flexible tab located at a downward and inward location of the flexible tab; and wherein the endpoint is engageable with and disengageable from the orifice for sliding the cup, the sleeve, and the outer shell relative to one another.

In some embodiments, the method includes the step of extending a slot in the sleeve in a longitudinal direction; and connecting the cup to the button through the slot in the sleeve. In further embodiments, the method extends a slot in the outer shell in a longitudinal direction; and connects the cup to the button through the slot in the outer shell.

In another embodiment, the method places an opening in the outer shell for permitting the cosmetic to protrude and optional includes attaching a door to the opening and connecting a spring to the door for biasing the door to a closed position.

In some embodiments, the method further comprises the step of engaging the endpoint with the orifice for permitting the sleeve and the cup to slide together; and disengaging the endpoint from the orifice for permitting the cup to slide relative to the sleeve.

In a further embodiment, the method places a detent on the sleeve for inhibiting the sleeve from moving through the opening.

### BRIEF DESCRIPTION OF THE DRAWINGS

FIGS. 1a-1c depict a cosmetic dispenser with a door transitioning from a closed position to an open position.

FIG. 2 depicts an assembly view of the cosmetic dispenser shown in FIGS. 1a-1c.

FIGS. 3a-3c depict cross sectional views of the cosmetic dispenser shown in FIGS. 1a-1c.

FIG. 4 depicts a close up perspective view of the cosmetic dispenser shown in FIGS. 1a-1c.

FIGS. 5a-5b more particularly depict the button assembly shown in FIGS. 1a-1c.

FIG. 6 depicts a method of providing the cosmetic dispenser shown in FIGS. 1a-1c.

FIG. 7 is another view of the guide shown in FIGS. 1a-1c.

### DETAILED DESCRIPTION OF THE INVENTION

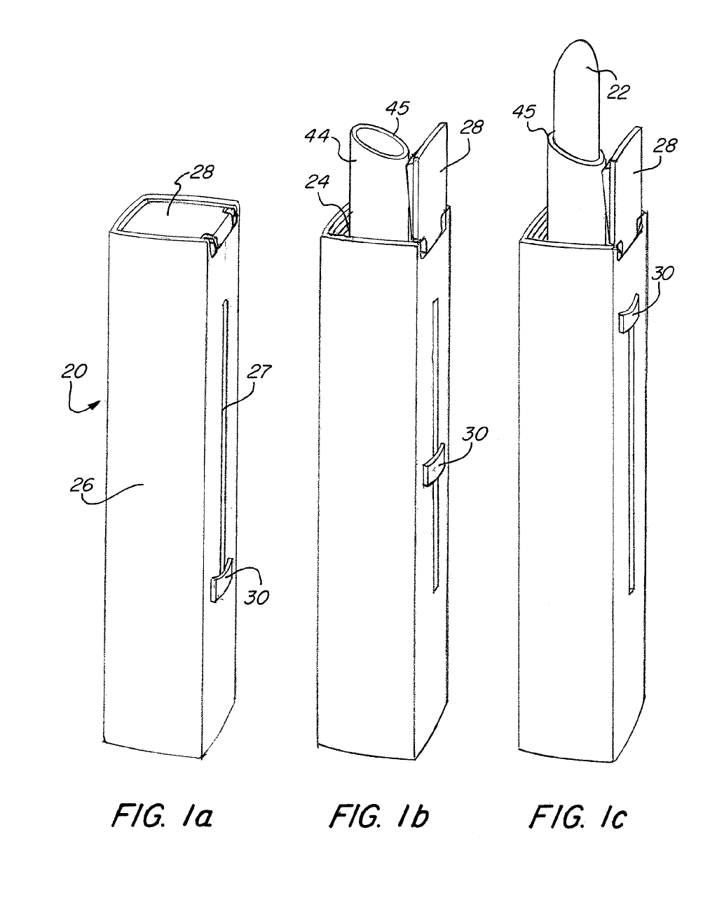

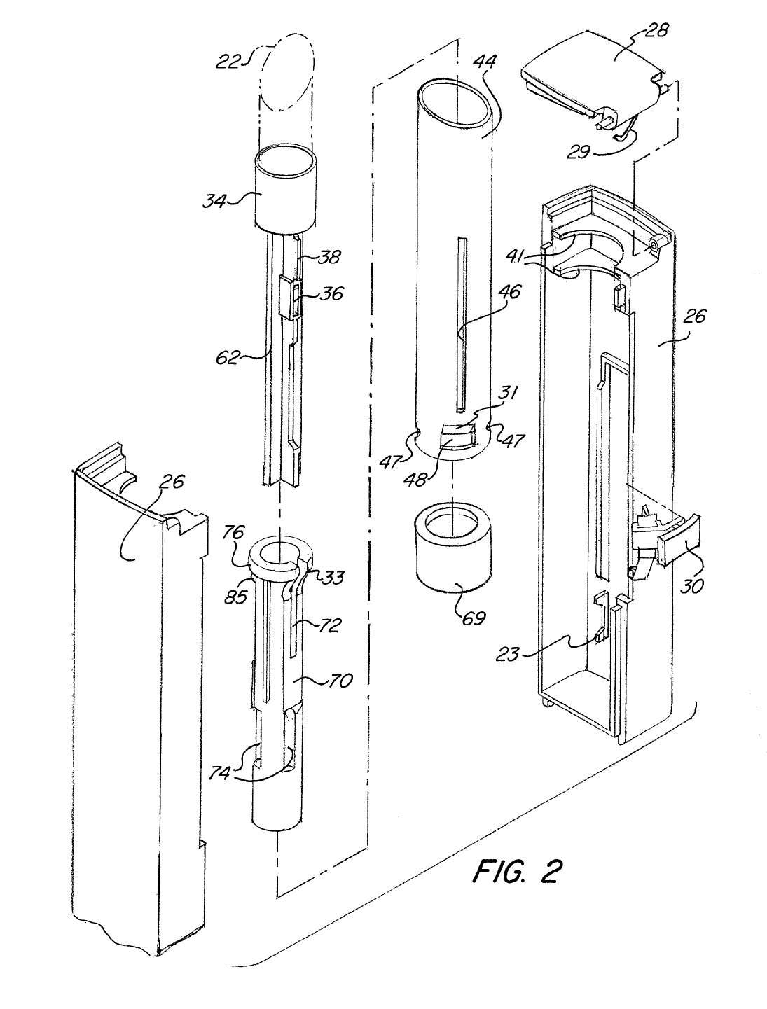

As shown in FIGS. 1a-1c, cosmetic dispenser 20 is shown with door 28 in a closed position (with cosmetic 22 in a retracted position) transitioning to an open position (with cosmetic 22 in an extended position).

As shown, outer shell 26 includes opening 24 for sleeve 44 and cosmetic 22 to protrude such that a user may apply cosmetic 22. Also as shown, button 30 moves upward as door 28 is opened from a closed position (FIG. 1a) to an open position (FIG. 1c) and button 30 moves downward as door 28 is closed from an open position. In some embodiments, a movement of button 30 is linearly related to a movement of door 28, whether in the upward or downward direction.

As shown, door 28 is opened by sleeve 44 extending upward from dispenser 20 from the closed position of FIG. 1a. As sleeve 44 extends upward due to a user moving button 30 upward, and if the force applied to button 30 in an upward direction is greater than a biasing spring connected to door 28 for biasing door to a closed position, door 28 will open. Once door 28 is open and sleeve 44 is in a fully extended position, continued upward movement of button 30 will cause cosmetic 22 to protrude or extend out of sleeve 44.

In the reverse direction, movement of button 30 downwardly causes cosmetic 22 to likewise move downwardly until it passes at least upper most part 45 of sleeve 44 before sleeve 44 begins to retract downwards. As sleeve 44 retracts downwards, door 28 closes due to biasing spring 29.

In this fashion, sleeve 44 maintains door 28 in an open position before cosmetic 22 protrudes out of dispenser 20 and sleeve maintains door 28 stays in an open position until cosmetic 22 is below upper most part 45 before door 28 can close. Therefore, cosmetic 22 is inhibited from coming into contact with door 28, resulting in a smudged or marred door 28 and/or smudged or damaged cosmetic 22. By inhibiting contact between cosmetic 22 and door 28, sleeve 44 reduces bacterial growth/transmission between cosmetic 22 and door 28.

One advantage of sleeve 44 being moveable upwards and downwards is that it provides a physical barrier between cosmetic 22 and door 28, wherein proper engagement or functionality of door opening mechanisms, locks, and/or latches is obviated. Moreover, failures of prior art door opening mechanisms, locks, and/or latches that may result in contact between cosmetic 22 and door 28 is also avoided since sleeve 44, despite any of the above failures, still presents a physical barrier and inhibits any contact.

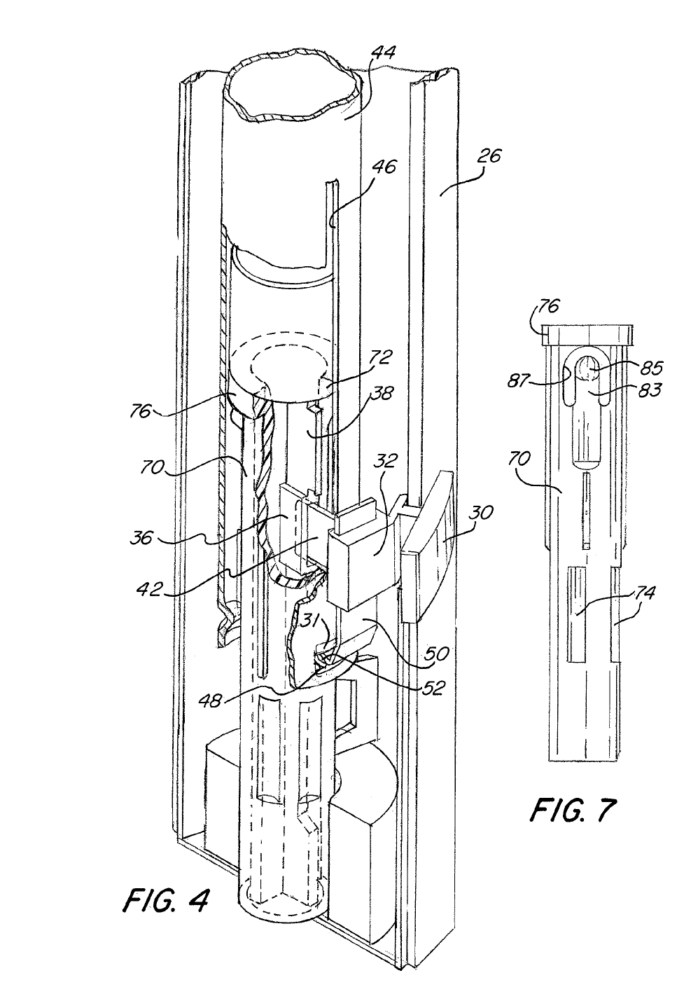

FIG. 2 depicts an assembly view of dispenser 20, including elevator cup 34 for holding cosmetic 22 and cup/bar connector 36 for connecting cup 34 to bar 42 (see FIGS. 4-5b for a description of bar 42 being fixedly attached to button 30 and cup 34 via connector 36).

As shown, cup 34 and shaft 62 fit within guide 70, wherein guide 70 includes slot 72 for permitting bar 42 to move axially, or longitudinally, without being inhibited by guide 70. When cosmetic 22 is in a fully retracted position, shaft and cup/bar connector 36 is within guide 70 and when button 30 moves upwardly, bar 42 and cup 34 likewise move upwardly. Such movement would be inhibited if slot 72 were absent. Similarly, slot 72 permits bar 42, cup 34, and button 40 to move downwardly without hindrance when cosmetic 22 is being moved from the extended position to the retracted position.

Guide 70 also includes at least one recess 74 for engaging with at least one extender 23 on outer shell 26, wherein such engagement inhibits rotation of guide 70. Rotation of guide 70, and for that matter sleeve 44, is undesirable since it places stress and friction upon bar 42 passing through slots 72, 46 and such friction inhibits movement of button 30. Although several recesses are shown, other embodiments use one recess 74 so long as rotation of guide 70 is minimized.

Guide 70 further includes stop 76, which is shown to be a flange that is molded as a part of guide 70. In other embodiments, stop 76 is attached or fastened to guide 70. It is important to note slot 72 passes through or extends through stop 76.

In additional embodiments, shaft 62 includes protrusion 38 that protrudes from shaft 62 into slot 72 for inhibiting cup 34 and shaft 62 from rotating relative to guide 70, wherein rotation increases stress and functionality on button 30 and bar 42.

Referring to FIG. 2, guide 70 fits within sleeve 44 and, in some embodiments, cup 34 slides relative to sleeve 44. In other embodiments, cup 34 and sleeve 44 move in unison.

As shown, sleeve 44 includes slot 46 extending in a longitudinal direction, or axially, and orifice 48 placed below slot 46. When fully assembled as shown in FIGS. 1a-1c, bar 42 extends from button 30 inward through slot 46 and slot 72 until it is fixed to cup/bar connector 36. As shown, door 28 includes spring 29 for biasing door 28 in a closed position.

Sleeve 44 also includes detent 47 that inhibits upward movement of sleeve 44 when detent 47, which is a crimped diameter of sleeve 44, comes in contact with stop 76 because a diameter of detent 47 is smaller than a diameter of stop 76. In some embodiments, detent 47 is a ring that is attached to an inner diameter of sleeve 44. In other embodiments, detent 47 extends around a part of the inner diameter of sleeve 44. All that is required of detent 47 is for it to inhibit movement of sleeve 44 once it contacts stop 76, which typically occurs when a diameter of detent 47 is smaller than a diameter of stop 76. Weight 69 is placed at a lower end of dispenser 20 for providing proper feel to the user.

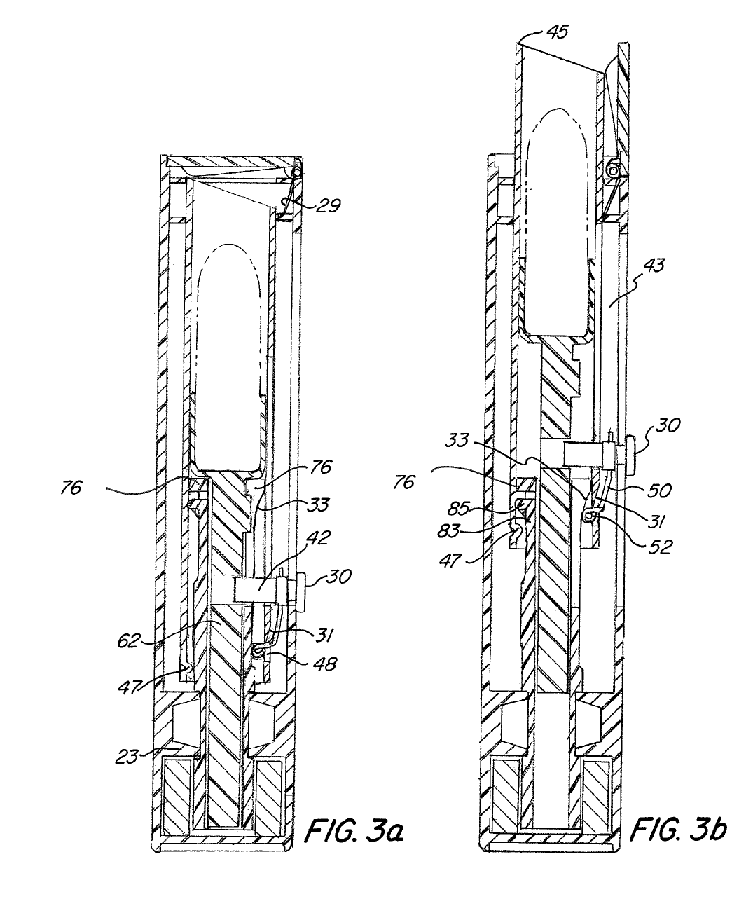

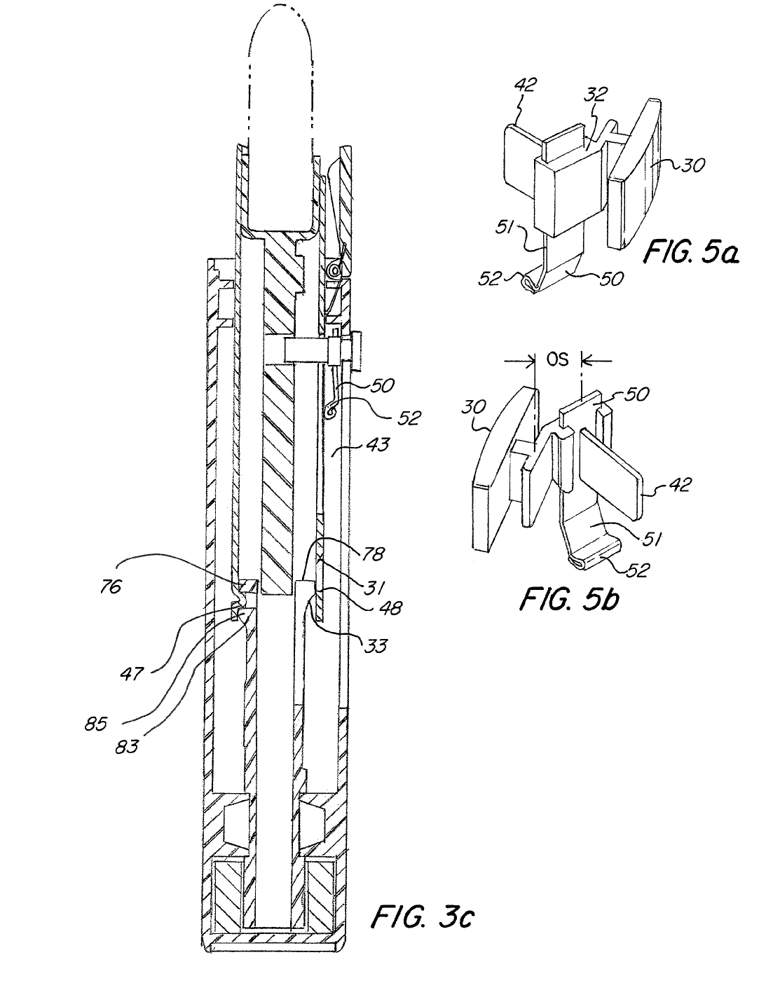

FIG. 3a depicts a cross section of dispenser 20 showing door 28 in a closed position. FIGS. 3a and 4 show button 30 is rigidly connected to bar 42, which passes through slots 46, 72 and is rigidly connected to cup 34 via cup/bar connector 36. Since button 30 is connected to cup 34, a movement of button 30 in an upward or downward direction will cause cup 34 to likewise move in an upward or downward direction. In some embodiments, the movement of button 30 and cup is in unison with one another.

In addition, bar 42, which is held in place with holder 32, includes flexible hook 50 extending downward and inward from bar 42 and button 30 toward sleeve 44, where endpoint 52 of tab 50 is located at a most downward and inward location of tab 50 (see also FIGS. 5a-5b). As shown, endpoint 52 is engaged with orifice 48 and because of this engagement, movement of button 30 causes sleeve 44 to move in unison with button 30. Since cup 34 is rigidly connected to button 30, the three members of cup 34, button 30, and sleeve 44 move together when endpoint 52 is engaged with orifice 48. In some embodiments, tab 50 is a leaf spring.

As shown in FIGS. 5a-5b, button 30 and flexible hook 50 are offset by holder 32, which extends in a lateral direction (offset identified as OS in the figures), or radial direction when assembled with dispenser 20, such that tab 50 is not in front of button 30 but is to a side of button 30. In some embodiments, slots 46 and 72 are not visible from slot 27 in outer shell 26 and this inhibits dirt or debris from entering slots 46, 72 through slot 27, which may contaminate cosmetic 22 and/or hinder various components within dispenser 20 to operate properly.

In further embodiments, hiding slots 46, 72 enhances aesthetic appeal of dispenser 20 since a user when viewing slot 27 will see sleeve 44, which may have a high gloss finish, as opposed to the complicated mechanisms of slots 46 and 72, tab 50, and orifice 48

In other embodiments, this offset OS, or lateral distance between button 30 and tab 50, provides adequate room for maneuvering tab 50 to be optimally placed within holder 32 such that endpoint 52 is optimally placed for engagement and disengagement with orifice 48.

Also as shown in FIGS. 5a-5b, bar 42 extends from tab 50 to rigidly engage with connector 36 so that movement of button 30 translates immediately to an identical or similar movement of cup 34. In another embodiment, bar 42 extends directly from holder 32. In a further embodiment, tab 50, bar 42, and holder 32 are integrally connected.

FIG. 3b depicts a cross section of dispenser 20 showing door 28 in an open position and sleeve 44 protruding outward to prop door 28 open. Cosmetic 22 is below upper most part 45 and is hidden within sleeve 44. As button 30 is moved upward by a user, sleeve 44 moves upward as well since endpoint 52 is engaged with orifice 48. As sleeve 44 moves upward, it props door 28 open (assuming a user is exerting a force that overcomes the biasing force of spring 29) as shown.

Sleeve 44, cup 34, and button 30 move upwardly together as button 30 is moved upwardly by a user until detent 47 comes in contact with stop 76, at which point sleeve 44 is inhibited from further upward movement. As shown in FIGS. 3b-3c, continued upward movement of button 30 causes endpoint 52 to disengage from orifice 48.

Contemporaneously, but not necessarily at the exact same time, endpoint 52 comes in contact with angled surface 33 when detent 47 comes in contact with stop 76. In other embodiments, the detent 47 comes in contact with stop 76 well after endpoint 52 contacts angled surface 33. Angled surface 33 facilitates a movement of endpoint 52 from engagement within orifice 48 to disengagement from orifice 48. Referring to FIG. 3b, sleeve 44, button 30, and cup 34 move in unison because endpoint 52 is engaged with orifice 48 even after endpoint 52 comes in contact with angled surface 33, at which point continued upward movement of button 30 by user causes endpoint to slide along surface 33 while still engaged with orifice 48.

This upward movement of endpoint 52 will cause ramp 31 to move upward until it is approximately flush with or slightly upward from surface 33, at which point endpoint 52 will transition from surface 33 to ramp 31 and then out of orifice 48, resulting in endpoint 52 disengaging from orifice 48. This approximately flush relationship between surface 33 and ramp 31 is shown in FIG. 3c.

In some embodiments, the surface of endpoint 52 and tab 50 is smooth or without encumbrances so that tip 31′ of ramp 31 does not become caught in or entangled with tab 50, which is why the design of tab 50 and endpoint 52 show endpoint being bent or folded over on a side of tab 50 opposite ramp 31 (see FIGS. 3b and 5b). As shown, tip 31′ slides along inside 51, or an unencumbered side, of tab 50 in order for sleeve 44 to move upward as endpoint 52 slides along surface 33.

In other embodiments, and as shown in FIGS. 2, 3a-3c, and 4, ramp 31 together with angled surface 33 of stop 76 facilitate the engagement and disengagement of endpoint 52 from orifice 48. Without ramp 31 and angled surface 33, an excessive amount of force may be required from the user to be applied to button 30 in order to accomplish the disengagement. In some of these embodiments, the excessive force may be destructive to the components of dispenser 20, such as button 30 or .flexible hook 50.

FIG. 3c depicts a cross section of dispenser 20 showing door 28 in an open position, sleeve 44 protruding outward to prop door 28 open, and cosmetic 22 in a fully extended position for application to a user. As shown, endpoint 52 is disengaged from orifice 48, which results in button 30 and cup 34 moving upward relative to sleeve 44 and cup 34 sliding upwards while still positioned within sleeve 44. In this fashion, sleeve 44 props open door 28 and cosmetic 22 is permitted to protrude upwards out of sleeve 44 for application.

As shown in FIG. 3c, cup 34 slides upwards/downwards relative to, or independent from, sleeve 44 and this occurs when endpoint 52 is disengaged from orifice 48. As shown, flexible hook 50 flexes to fit within space 43 between sleeve 44 and outer shell 26 and is biased to return to an unflexed position, which is why a downward movement of flexible hook 50 where endpoint 52 is positioned adjacent orifice 48 will result in endpoint re-engaging with orifice 48 since tab 50 is biased to unflex or expand. Ramp 31 and surface 33 facilitate re-engagement as endpoint 52 moves downward toward orifice 48.

In some embodiments, to maintain sleeve 44 in the position shown in FIG. 3c propping door 28 open while endpoint 52 is disengaged from orifice 48, friction between sleeve 44 and other components, such as stop 76 or inner flange 41 of shell 26, inhibits sleeve 44 from sliding downward which would result in door 28 going to a closed position while cosmetic 22 is exposed. Therefore, friction is desired between sleeve 44 and these other components, which in other embodiments include other parts of shell 26, because the friction inhibits sleeve 44 from sliding downward resulting in premature closing of door 28.

In some embodiments, guide 70 includes flexible stop 83 with flange 85 extending laterally from flexible stop 83 to more securely hold sleeve 44 in the extended position shown in FIG. 3c. Because sleeve 44 is more securely held, door 28 is less likely to come in contact with cosmetic 22.

As shown in FIGS. 3b, 3c, and 7, flexible stop 83 is a horseshoe-shaped cut 87 in guide 70 at a location under which detent 76 passes and at a location below stop 76. As sleeve 44 is moved upwards to the position shown in FIG. 3c, detent 47 comes in contact with flange 85 of flexible stop 83. Continued upward movement of sleeve 44 causes flexible stop 83 to flex or bend radially inwards, facilitating upward movement of sleeve 44 since flange 85 also moves radially inwards and will less likely inhibit upward movement of sleeve 44.

Once detent 47 and sleeve 44 passes flange 85, flexible stop 83 returns to its originally unflexed position, wherein detent 47 is now positioned (in an axial direction) between flange 85 and stop 76 (as described above stop 76 inhibits continued upward movement of sleeve 44). Because flange 85 inhibits detent 47 from moving downwardly (without the user's intentional downwardly applied force, as described more fully below), sleeve 44 is likewise inhibited from moving downwardly and therefore keeps door 28 in an open position, wherein contact between cosmetic 22 and door 28 is less likely to occur.

When the user moves sleeve 44 downwardly (as described above, this occurs after cosmetic 22 has been retracted and door 28 is still in the open position), he/she must exert enough downward force to overcome the force caused by flange 85 pressing against detent 47. Once the user exerts enough force, flexible stop 83 again flexes or bends radially inwards to permit detent 47 to pass over, after which sleeve 44 retracts toward the position shown in FIG. 3b.

In a further embodiment, downward movement of sleeve 44 occurs after bar 42 comes in contact with the lowest part of slot 46, which also ensures cosmetic 22 is retracted beneath upper most part 45.

As stated above, at least one recess 74 and at least one rib 23 inhibits guide 70 from rotating and bar 42 passing through sleeve 44 inhibits sleeve 44 from rotating. Therefore, cooperation between flexible stop 83 and detent 76 in an axial direction is feasible where the likelihood of detent 47 and stop 83 passing around each other is minimized due to their minimized rotation.

On the other hand, in another embodiment, friction between cup 34 and sleeve 44 as well as sleeve 44 and endpoint 52 is minimized so that when cup 34 and tab 50 are moved downwardly to a retracted position, the friction between cup 34 and/or tab 50 and sleeve 44 does not cause sleeve 44 to move downwardly with cup 34/button 30. Instead, both cup 34 and endpoint 52 should ideally slide freely relative to sleeve 44 in a downward direction until endpoint 52 is engaged with orifice 48. Hence, in some embodiments, the high gloss finish of sleeve 44 described above serves not only an aesthetic purpose, but a functional one as well since it reduces friction between sleeve 44 and endpoint 52. In a further embodiment, endpoint 52, tab 50, or cup 34 is also of a high gloss finish. In another embodiment, grease or its equivalent is placed between cup 34 and sleeve 44 or between endpoint 52 and sleeve 44 to minimize friction. In other embodiments, the materials used for cup 34, endpoint 52, and sleeve 44 are of a slippery nature or are coated with materials that assist in minimizing friction, such as molybdenum or Teflon.

Therefore, although friction between sleeve 44 and inner flange 41, stop 76, or other components assists in sleeve 44 maintaining door 28 in an open position and hinders door 28 from prematurely closing 28 should sleeve 44 slide downward without enough friction, friction between sleeve 44, endpoint 52, and cup 34 should be minimized for the same reasons of maintaining door 28 in an open position until endpoint 52 engages with orifice 48, at which point sleeve 44 should move downwardly to close door 28.

More specifically, when detent 47 is in contact with stop 76 (FIG. 3b), the amount of force exerted upon button 30 in order to move cup 34 upward toward the position shown in FIG. 3c exceeds the normal frictional force between cup 34 and sleeve 44. If this were not the case and the normal frictional force between cup 34 and sleeve 44 were greater than the force exerted upon button 30, then in the downward movement of button 30 from FIG. 3c to FIG. 3b (to retract cosmetic 22 and close door 28) would result in sleeve 44 moving downward with cup 34 (due to a user's downward force on button 30) before endpoint 52 engages with orifice 48, and this would result in a premature closing of door 28 upon cosmetic 22.

In addition, shaft 62 remains within an inner diameter of guide 70 or does not protrude beyond upper most part 78 of guide 70. In this fashion, shaft 62 acts as a pilot so that cup 34 is sufficiently aligned along a longitudinal direction with guide 70 and sleeve 44. Without shaft 62 remaining within an inner diameter of guide 70, cup 34 may not be able to retract to a closed position because cup 34 or some part connected to cup 34 may hit upper most part 78 of guide 70, and thereafter not be able to retract below upper most part 78 and which is needed for sleeve 44 to retract and door 28 to fully close.

In addition to upward movement of button 30 to disengage endpoint 52 from orifice 48, detent 47 coming in contact with stop 76 further facilitates such disengagement because the combination of upward movement by the user of button 30 together with sleeve 44 being unable to move due to stop 76 will result in an easier disengagement of endpoint 52 from orifice 48 as opposed to simply upward movement of button 30 without stop 76.

Since sleeve 44 is inhibited from further movement out of opening 24 of outer shell 26 due to stop 76 coming in contact with detent 47, and since upward movement of cup 34 is unrestricted, a user may disengage endpoint 52 from orifice 48 easily.

In some embodiments, disengagement is further facilitated due to flexible hook 50 being of resilient material wherein the material flexes when placed under strain by tab 50 being moved upward relative to sleeve 44. Wherein tab 50 flexes to be disengaged from orifice 48 and be compacted in space 43 between sleeve 44 and outer shell 26. If the material were brittle and rigid, it would be more difficult for tab 50 to flex, and therefore disengage from orifice 48.

In addition, since the material is resilient, and being flexed when disengaged by being constricted in space 43, the material should have a sufficiently high or large elastic deformation region such that the material tends to spring back or flex back to the original shape when the strain is removed. In other words, when button 30 and flexible hook 50 are moved downwardly, endpoint 52 tends to engage with orifice 48 due to the spring-like nature of tab 50 being of a material that has not been plastically deformed.

If the material were plastically deformed, tab 50 and endpoint 52 would not re-engage with orifice 48 when button 30 is moved downwardly to retract cosmetic 22 since the material, and therefore tab 50 and endpoint 52, would remain fixed in the position shown in FIG. 3c.

The dispenser 20 described in this application is suitable for use with lipstick as well as cosmetic brushes, eye shadow, lip liners, blushes, and other cosmetics congealed into stick form. Reference to lipstick herein is intended to embrace these and other products of this kind.

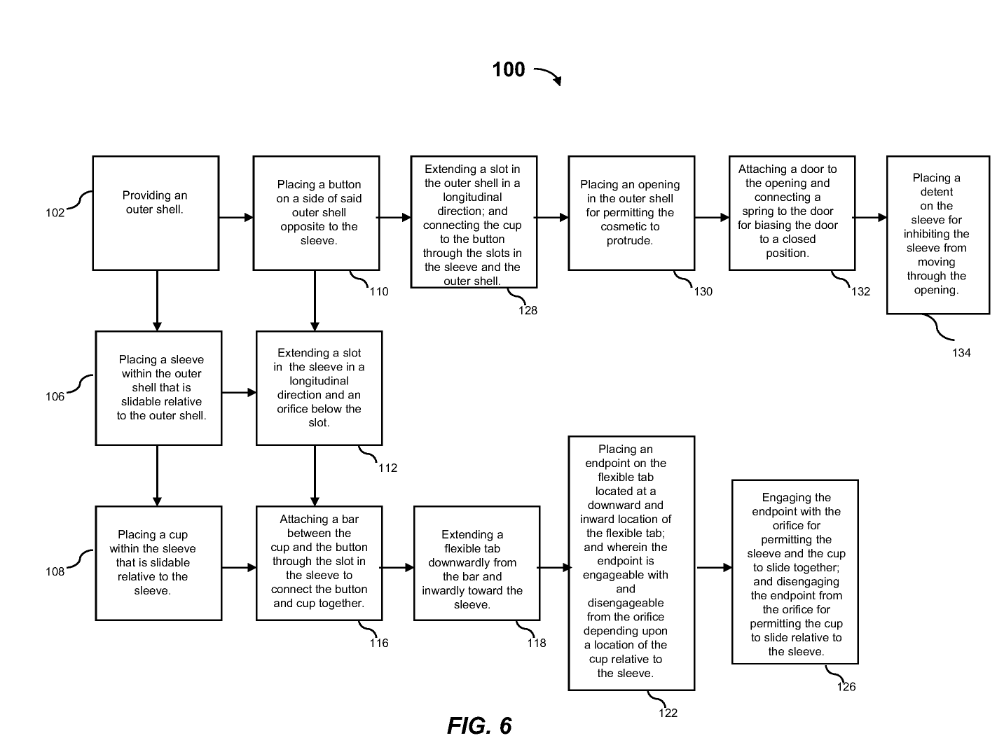

FIG. 6 depicts method 100 of providing cosmetic dispenser 20 shown in the above figures. Method 100 includes providing 102 an outer shell, placing 106 a sleeve within the outer shell that is slidable relative to the outer shell, and placing 108 a cup within the sleeve that is slidable relative to the sleeve.

In some embodiments, method 100 places 110 a button on a side of the outer shell opposite to the sleeve, extends 112 a slot in the sleeve in a longitudinal direction and an orifice below the slot, and extends 128 a slot in the outer shell in a longitudinal direction for connecting the cup to the button through the slots in the sleeve and the outer shell.

In a further embodiment, method 100 includes the steps of placing 130 an opening in the outer shell for permitting the cosmetic to protrude, attaching 132 a door to the opening and connecting a spring to the door for biasing the door to a closed position, and placing 134 a stop on the sleeve for inhibiting movement of the sleeve through the opening.

In other embodiments, method 100 includes the steps of attaching 116 a bar between the cup and the button through the slot in the sleeve to connect the button and cup together, extending 118 a flexible tab downwardly from the bar and inwardly toward the sleeve, and placing 122 an endpoint on the flexible tab located at a downward and inward location of the flexible tab. In an optional embodiment, method 100 engages 126 the endpoint with the orifice for permitting the sleeve and the cup to slide together and disengages the endpoint from the orifice for permitting the cup to slide relative to the sleeve.

What is claimed is:

1. A cosmetic dispenser for dispensing a cosmetic, comprising:
an outer shell;
a sleeve placed within said outer shell and slidable relative to said outer shell;
a cup placed within said sleeve and slidable relative to said sleeve;
said sleeve having an orifice;
a button located on a side of said outer shell opposite to said sleeve;
a bar placed between and attached to said cup and said button;
a flexible tab extending downwards from said bar and inwards toward said sleeve, said flexible tab having an endpoint located at a downward and inward location of said flexible tab; and
wherein said endpoint is engageable with and disengageable from said orifice for sliding said cup, said sleeve, and said outer shell relative to one another.

2. The cosmetic dispenser according to claim 1, wherein said outer shell includes a slot extends in a longitudinal direction and said bar extending through said slot in said outer shell.

3. The cosmetic dispenser according to claim 1, wherein said sleeve includes a slot extends in a longitudinal direction above said orifice and said bar extending through said slot in said sleeve.

4. The cosmetic dispenser according to claim 1, wherein said outer shell includes an opening for permitting the cosmetic to protrude.

5. The cosmetic dispenser according to claim 4, wherein further comprising a door attached to said opening and a spring connected to said door for biasing said door to a closed position.

6. The cosmetic dispenser according to claim 1, wherein said endpoint engages with said orifice when said sleeve and said cup slide together; and wherein said endpoint disengages from said orifice when said cup slides relative to said sleeve.

7. The cosmetic dispenser according to claim 1, wherein said flexible tab is a leaf spring.

8. The cosmetic dispenser according to claim 1, wherein said sleeve has a detent for inhibiting said sleeve from moving through said opening.

9. The cosmetic dispenser according to claim 1, wherein said flexible tab is accurate in shape as it extends downward from said bar and inward toward said sleeve.

10. A cosmetic dispenser for dispensing a cosmetic, comprising:
an outer shell with a slot extending in a longitudinal direction;
a sleeve placed within said outer shell and slidable relative to said outer shell;
a cup placed within said sleeve and slidable relative to said sleeve;
said sleeve having an orifice and a slot extending in a longitudinal direction above said orifice;
a button located on a side of said outer shell opposite to said sleeve;
a bar extending from said button, through said slots in said sleeve and outer shell, and to said cup for connecting said button and said cup together;
a flexible tab extending downwards from said bar and inwards toward said sleeve, said flexible tab having an endpoint located at a downward and inward location of said flexible tab; and
wherein said endpoint is engaged with said orifice for sliding said cup and said sleeve together; and
wherein said endpoint is disengaged from said orifice for sliding said cup relative to said sleeve.

11. A method of providing a cosmetic dispenser for dispensing a cosmetic, comprising the steps of:
providing an outer shell;
placing a sleeve within the outer shell that is slidable relative to the outer shell;
placing a cup within the sleeve that is slidable relative to the sleeve;
placing an orifice in the sleeve;
placing a button on a side of said outer shell opposite to the sleeve;
attaching a bar between the cup and the button to connect the button and cup together;
extending a flexible tab downwardly from the bar and inwardly toward the sleeve;
placing an endpoint of the flexible tab located at a downward and inward location of the flexible tab; and
wherein the endpoint is engageable with and disengageable from the orifice for sliding the cup, the sleeve, and the outer shell relative to one another.

12. The method according to claim 11, further comprising the step of extending a slot in the sleeve in a longitudinal direction; and connecting the cup to the button through the slot in the sleeve.

13. The method according to claim 11, further comprising the step of extending a slot in the outer shell in a longitudinal direction; and connecting the cup to the button through the slot in the outer shell.

14. The method according to claim 11, further comprising the step of placing an opening in the outer shell for permitting the cosmetic to protrude.

15. The method according to claim 14, further comprising the step of attaching a door to the opening and connecting a spring to the door for biasing the door to a closed position.

16. The method according to claim 11, further comprising the step of engaging the endpoint with the orifice for permitting the sleeve and the cup to slide together; and disengaging the endpoint from the orifice for permitting the cup to slide relative to the sleeve.

17. The method according to claim 11, further comprising the step of placing a detent on the sleeve for inhibiting the sleeve from moving through the opening.

18. A method of providing a cosmetic dispenser, comprising the steps of:
providing an outer shell with an opening and a door attached to the opening;
placing a sleeve with an orifice within the outer shell;
placing a cup within the sleeve;
extending a flexible tab downwardly from the outer shell and inwardly toward the sleeve;
placing an endpoint of the flexible tab located at a downward and inward location of the flexible tab;
engaging the endpoint with the orifice and moving the sleeve through the opening to open the door; and
disengaging the endpoint from the orifice and moving the cup relative to the sleeve toward the opening for dispensing a cosmetic within the cup.

19. The method according to claim 18, further comprising the steps of:
placing a button on a side of the outer shell opposite to the sleeve;
connecting the button to the cup and to the flexible tab;
moving the button toward the opening while the endpoint is engaged with the orifice to move the sleeve through the opening to open the door;
protruding the sleeve through the opening to maintain the door in an open position;
moving the button toward the opening while the endpoint is disengaged from the orifice to move the cup relative to the sleeve for exposing the cosmetic.

20. The method according to claim 18, further comprising the steps of:
moving the button relative to the sleeve and away from the opening to retract the cosmetic; and
moving the button and sleeve together away from the opening by engaging the endpoint with the orifice to close the door.
